(19) United States
(12) Patent Application Publication
(10) Pub. No.: US 2008/0301723 A1
(43) Pub. Date: Dec. 4, 2008

(54) OPTICAL DISC APPARATUS

(75) Inventor: Naoki Eguchi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/127,378

(22) Filed: May 27, 2008

(30) Foreign Application Priority Data
May 31, 2007 (JP) 2007-145270

(51) Int. Cl. G11B 17/04

(52) U.S. Cl. 720/620

(57) ABSTRACT

An optical disc apparatus includes a cam slider with a rack-gear section. The cam slider includes a first sloping surface that is elastically deformed, generating a force for separating the rack-gear section from the cam slider, when receiving a force that acts in the same direction as to eject an optical disc, and a second sloping surface that generates a force for coupling the rack-gear section to the cam slider again, when pressed with a force that acts in the same direction as the rack-gear section separated from the cam slider ejects an optical disc. The cam slider is moved in the direction opposite to the direction in which first and second guide arms transport the optical disc in order to load or eject the optical disc. The cam slider transmits a drive force provided by a loading motor to the first and second guide arms.

### CROSS-REFERENCE TO RELATED APPLICATIONS

This application is based upon and claims the benefit of priority from Japanese Patent Application No. 2007-145270, filed May 31, 2007, the entire contents of which are incorporated herein by reference.

### BACKGROUND

1. Field

One embodiment of the present invention relates to a slot-in type optical disc apparatus from which an optical disc can be reliably removed in emergency.

2. Description of the Related Art

Optical disc apparatuses include an optical pickup (optical head) device, a loading mechanism, and a disc motor. The optical pickup is moved over the data-recording surface of an optical disc in the radial direction thereof. While being so moved, the optical pickup can read data from the optical disc and can record data in the optical disc. The loading mechanism is configured to insert an optical disc to a prescribed position (in the optical disc drive) and to eject the disc reliably from the optical disc drive. The disc motor rotates the optical disc.

Optical disc apparatuses are classified into two types, i.e., a tray type and a slot-in type, in accordance with the type of the disc loading mechanism that pulls an optical disc to a prescribed position in the apparatus and reliably ejects the optical disc from the apparatus. The tray-type has a tray that holds a cartridge containing an optical disc. When the tray is projected from the apparatus, the optical disc (or cartridge) can be placed on the tray. The slot-in type is an optical disc apparatus into which an optical disc is pulled.

The slot-in type optical disc apparatus can be thin and is therefore widely used as a built-in type optical disc apparatus for use in audio-video systems for use in car, personal computers, and the like.

The optical disc must be reliably removed from the optical disc apparatus in emergency, when the apparatus is stopped due to, for example, the failure of the power supply, while the optical disc is being pulled into or ejected from the optical disc apparatus.

Particularly, the slot-in type must be overhauled, more often than not, after it has been removed from another apparatus, because of its structure. It is therefore demanded that the optical disc apparatus should be easily be removed in emergency, too.

Japanese Patent Application Publication (KOKAI) No. 2002-203354 discloses a recording-medium loading apparatus that has an ejection slider, an emergency pin, an emergency rack-and-pinion unit, and first and second gear units. The ejection slider can be manually driven (in normal condition) to eject an optical disc from an optical disc apparatus.

Various types have been proposed for such an ejecting mechanism as described in the Publication No. 2002-203354, which can be manually operated in emergency. As is known in the art, however, each type proposed must comprise many components and will inevitably render the apparatus large, though it is used only in emergency.

Further, in most slot-in type optical disc apparatus, the motor that serves as drive means is limited in size and torque. Due to this, the motor is engaged with a gear unit of a large reduction ratio. In this condition, it is difficult to eject the optical disc.

Even if the optical disc can be ejected in emergency, the optical disc apparatus can hardly be reset, in rather many cases, after the disc has been ejected from it. (In some cases, the apparatus needs to be repaired after the optical disc has been removed from it.)

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an optical disc apparatus according to an embodiment of the invention;

FIG. 2 is an exemplary diagram showing the optical disc apparatus shown in FIG. 1, with some components removed, and explaining how the disc motor and some components arrange around the motor are moved up and down (to chuck a disc);

FIG. 3 is an magnified exemplary view of the disc motor and turn table of the optical disc apparatus shown in FIG. 2, and some components arranged around the turn table;

FIG. 4 is an exemplary diagram showing the optical disc apparatus of FIGS. 1 and 2, representing how the disc motor is moved up and down as the camping ring is rotated;

FIGS. 5A and 5B are exemplary diagrams, explaining the principle of rotating the disc motor to move the motor to a standby position before an optical disc is inserted or ejected, of chucking an optical disc to the turntable of the disc motor, in the optical disc apparatus shown in FIGS. 1 to 4;

FIG. 6 is an exemplary diagrams explaining how the disc motor is rotated to release an optical disc from a clamped (chucked) state, or leasing the same from the turntable, in the optical disc apparatus shown in FIGS. 2 to 4;

FIGS. 7A to 7C are exemplary diagrams of the optical disc apparatus shown in FIGS. 2 to 4 explaining how the disc motor rotates as it is moved up and down (while remaining at the normal position);

FIGS. 8A to 8C are exemplary diagrams of the optical disc apparatus shown in FIGS. 2 to 4 explaining how the disc motor rotates as it is moved up and down;

FIGS. 9A to 9C are exemplary diagrams of the optical disc apparatus shown in FIGS. 2 to 4 explaining how the disc motor rotates as it is moved up and down;

FIGS. 10A and 10B are exemplary diagrams, each showing, in detail, how a 12-cm optical disc is inserted into the optical disc apparatus shown in FIGS. 1 to 4;

FIGS. 11A and 11B are exemplary diagrams, each showing, in detail, how an 8-cm optical disc is inserted into the optical disc apparatus according shown in FIGS. 1 to 4;

FIG. 12 is an exemplary diagram showing the loading arms and the disc holding lever, both at receded positions, so that optical disc inserted can rotate in the optical disc apparatus shown in FIGS. 1 to 4;

FIG. 13 is an exemplary diagram showing a configuration that can release the cam slider from a series of gears to make it easy to eject an optical disc in emergency in the optical disc apparatus shown in FIGS. 1 to 4;

FIG. 14 is an exemplary diagram showing the rack slider that can release the cam slider from a series of gears to make it easy to eject an optical disc in emergency in the optical disc apparatus shown in FIGS. 1 to 4;

FIG. 15 is another exemplary diagram showing the rack slider that can release the cam slider from a series of gears to make it easy to eject an optical disc in emergency in the optical disc apparatus shown in FIGS. 1 to 4;

FIGS. 16A to 16C are exemplary diagrams, each showing the cam slider released from the engagement with the series of gears, in order to make it easy to eject an optical disc in emergency in the optical disc apparatus shown in FIGS. 1 to 4;

FIG. 17 is an exemplary diagram showing the specific shape of a resin spring part that releases the cam slider from the engagement with the series of gears, in order to make it easy to eject an optical disc in emergency in the optical disc apparatus shown in FIGS. 1 to 4;

FIGS. 18A and 18B are exemplary diagrams, each showing the resin spring part in normal state, which releases the cam slider from the engagement with the series of gears, in order to make it easy to eject an optical disc in emergency in the optical disc apparatus shown in FIGS. 1 to 4;

FIGS. 19A and 19B are exemplary diagrams, each showing the resin spring part that is deformed in emergency, releasing both the cam slider and the rack slider in the optical disc apparatus shown in FIGS. 1 to 4; and

FIGS. 20A and 20B are exemplary diagrams, each showing the resin spring part at a position where the guide rib contacts the engagement wall, thanks to the sloping reset surface, after the deformed part of the resin spring part has abutted on the guide rib and further deformed at the end of a returning sequence that follows the emergency sequence.

### DETAILED DESCRIPTION

Various embodiments according to the invention will be described hereinafter with reference to the accompanying drawings. In general, according to one embodiment of the invention, an optical disc apparatus comprising: a disc motor which is configured to hold and rotate an optical disc; a loading motor which exerts a drive force for loading and chucking the optical disc to the disc motor and for ejecting the optical disc after the optical disc has been de-chucked from the disc motor; first and second guide arms which guide the optical disc to a chucking position where the disc should be chucked to the disc motor, by using the drive force provided by the loading motor; a disc-motor lifting mechanism which rotates the disc motor, thereby chucking the optical disc, when the first and second guide arms transport the optical disc to the chucking position where the disc should be chucked to the disc motor; a slider mechanism which is moved in a direction opposite to the direction in which the first and second guide arms transport the optical disc, in order to load or eject the optical disc, and which transmits a drive force provided by the loading motor to the first and second guide arms and to the disc-motor lifting mechanism; a transmission mechanism which transmits a drive force of the loading motor to the slider mechanism; and a cut off mechanism which cuts off the drive force being transmitted by the transmission mechanism from the loading motor to the slider mechanism.

Embodiments according to the present invention will now be explained hereinafter in detail with reference to the accompanying drawings.

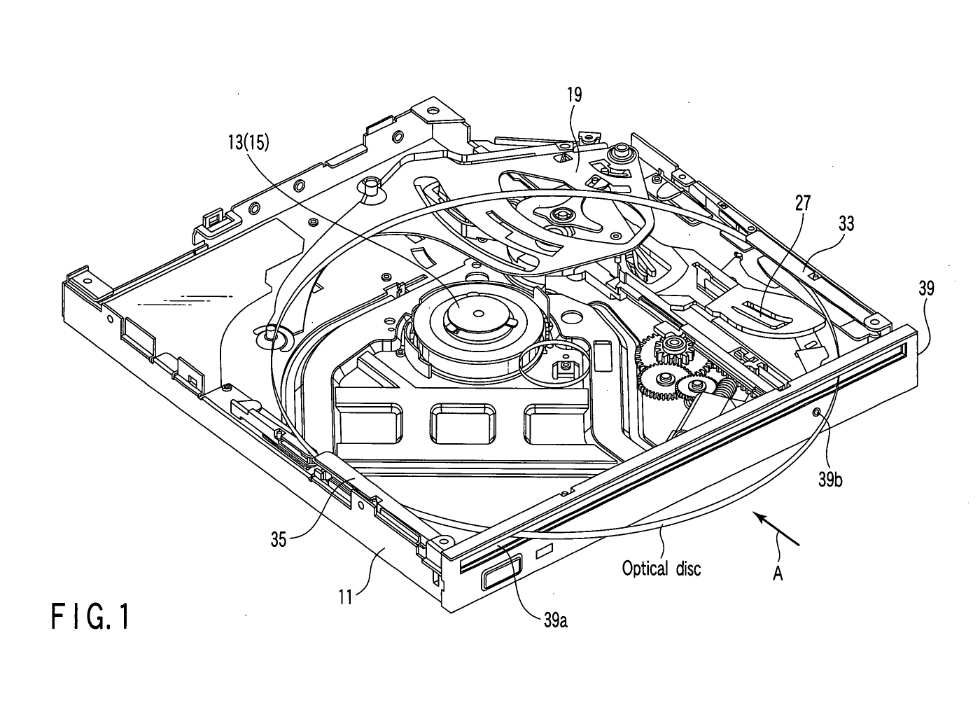

FIG. 1 shows an example of an optical disc apparatus according to an embodiment of the invention. The optical disc apparatus shown in FIG. 1 is a so-called slot-in type, in which an optical disc is inserted so that data may be recorded in and reproduced from, the optical disc. The optical disc apparatus is designed for use in, for example, portable personal computers (notebook PCs). FIG. 1 shows the optical disc apparatus, with some covers of the housing having been removed.

As shown in FIG. 1, the optical disc apparatus 1 has a chassis 11 and a disc motor 13 mounted on the center of the chassis 11. On the shaft (not shown) of the disc motor 13, a turntable 15 is mounted to hold an optical disc. The chassis 11 is formed of a relatively thin rolled metal plate.

Near the turntable 15, a loading arm 19 is provided. The loading arm 19 can rotate around a rotation axis is provided at a prescribed position on the chassis 11. The loading arm 19 is provided to support an optical disc inserted in the direction of arrow A and to guide the same to the turntable 15.

The loading arm 19 is connected by a connection lever 21 to a cam slider 27. The cam slider 27 can be driven by a series of gears 25 that transmits the rotation of a loading motor 23.

On the cam slider 27 a disc holding lever 29 is provided. The holding arm 29 can hold an optical disc inserted in the direction of arrow A. The holding arm 29 and the loading arm 19 are biased toward each other by a spring member 31.

A pair of disc guides (left and right disc guides) 33 and 35 are arranged in a direction at right angles to the direction of arrow W, in which the optical disc is inserted. The disc guides 33 and 35 support the optical disc at the outer circumference, while the loading arm 19 and disc holding lever 29 is loading the optical disc.

A bezel (front panel) 39 is integrally formed with the chassis 11. The bezel 39 has an insertion slot 39a and a pin insertion hole 39b. Through the insertion slot 39a, an optical disc can be inserted in the direction of arrow A. Through the pin insertion hole 39b, a release pin shaped like a wire can be inserted to release the loading motor 23 from the mesh (engagement) with the gears 25, in emergency (in order to eject the optical disc at the occurrence of, for example, a loading error).

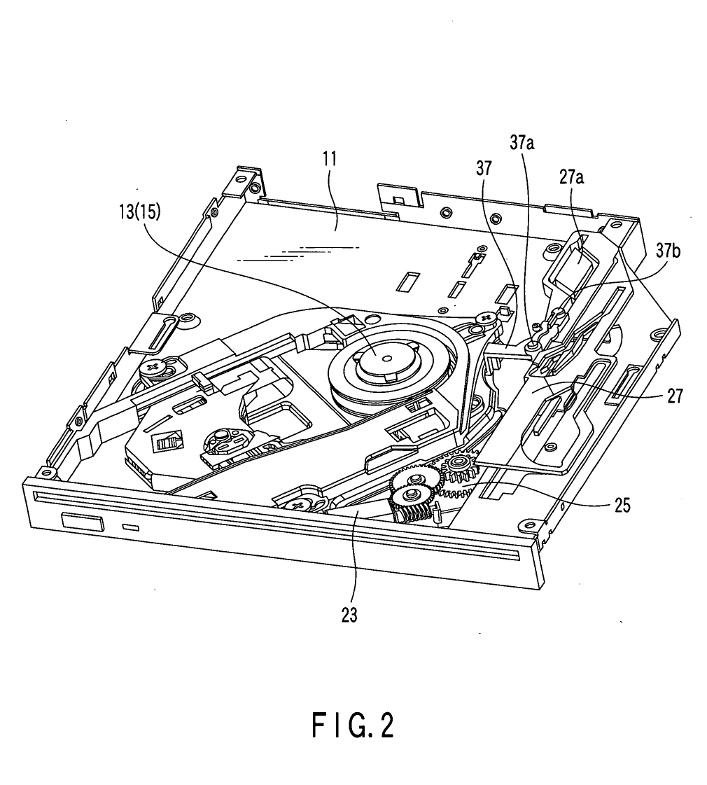

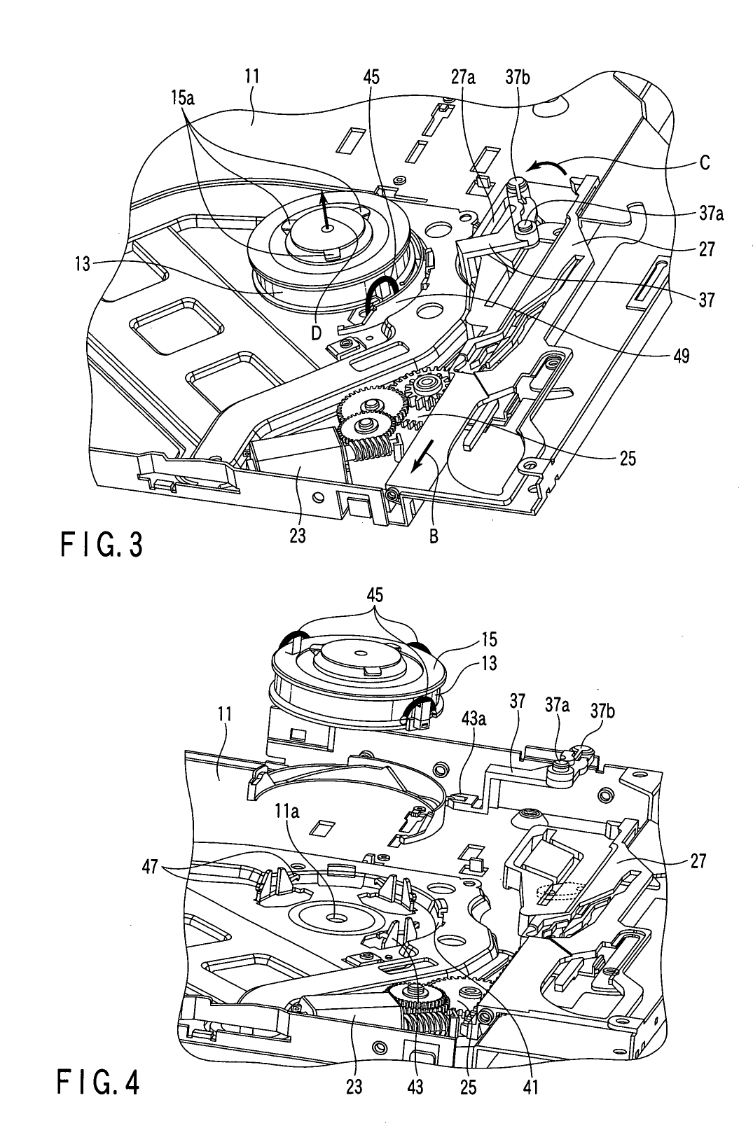

FIGS. 2 and 3 shows how the disc motor and some components provided around the disc motor are moved up and down, not showing some components shown in FIG. 1.

As clearly seen from FIG. 2, a clamp lever 37 is provided at a prescribed position on the disc motor 13 and turntable 15. The disc motor 13 is positioned at almost the center of the chassis 11. The turntable 15 is integrally formed with the disc motor 13. The clamp lever 37 is configured to rotate the turntable 15a and the disc motor 13, exerting a thrust that chucks an optical disc to the turntable 15. The clamp lever 37 is operated when the cam slider 27 is moved to a prescribed position in the chassis 11.

FIG. 3 shows how the clamp lever 37 is rotated in the direction of arrow C when the cam slider 27 is moved in the direction of arrow B (i.e., in the direction opposite to that in which an optical disc is inserted).

FIG. 4 shows how the disc motor is moved up and down as the camping ring explained with reference to FIGS. 2 and 3 is rotated.

Since the optical disc apparatus 1 shown in FIG. 1 is a slot-in type, it performs a loading operation to transport an optical disc to the housing and an ejecting operation to eject the optical disc from the housing. In most cases, the disc motor 13 remains off the path along which the optical disc moves, until the optical disc is guided to a prescribed position (clamping position), and similarly until the optical disc is ejected from the optical disc apparatus.

To keep the disc motor 13 off the path along which the optical disc moves, the housing (motor case) of the disc motor 13 and the chassis 11 of the optical disc apparatus 1 are appropriately designed as will be described below. The disc motor 13 as a whole is therefore rotated around its shaft. The disc motor 13 (particularly, the turntable 15) can therefore approach the chassis 11, moving away from the path along which the optical disc moves.

As shown in FIG. 4, a ring guide wall 41 is provided substantially at the center of the chassis 11. The ring guide wall 41 is coaxial to the rotation axis 11a of the disc motor 13 (i.e., the axis of the motor shaft) set in place and has a diameter slightly larger than the outer diameter of the motor case housing the disc motor 13.

A plurality of, for example three, lift guides 43 are provided arranged between the ring guide wall 41 and the rotation axis 11a. The lift guides 43 are arranged on a circle having a diameter substantially equal to the diameter of the motor case and are spaced from one another at almost regular angular intervals of 90° or more. The lift guides 43 can restrict the position the disc motor 13 can take and can yet allow the disc motor 13 to move up and down (in a direction parallel to the shaft of the disc motor 13) as will be described below. Each lift guide 43 has a pair of hooks 47 that hold a motor-biasing spring 45. The motor-biasing springs 45 push the disc motor 13 onto the chassis 11 while the lift guides 43 keep holding the disc motor 13.

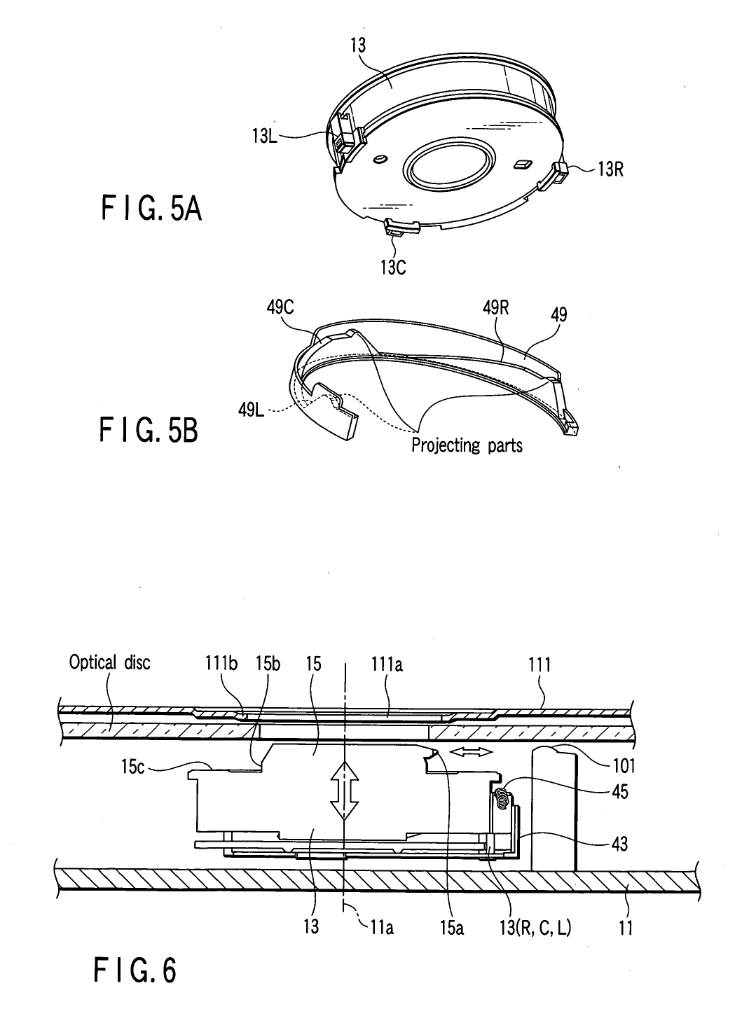

Cam-abutting projections 13R, 13C and 13L are provided on the outer circumferential surface of the hollow cylinder of the motor case and spaced at substantially the same angular intervals as the lift guides 43, as will be described later with reference to FIG. 5A. The cam-abutting projections 13R, 13C and 13L have the same phase as the lift cams 49R, 49C and 49L of the clamp ring 49, as will be described later with reference to FIG. 5B. In the process of assembling the optical disc apparatus 1, the cam-abutting projections 13R, 13C and 13L (FIG. 5A) are positioned at the lift cams 49R, 49C and 49L (FIG. 5B), respectively.

The load the motor-biasing springs 45 exert on the hooks 47 always pushes the motor case (disc motor 13) onto the lift cams 49R, 49C and 49L of the clamp ring 49. In this state, the motor case is held on the chassis 11. As shown in FIG. 5B, the lift cams 49R, 49C and 49L have a standby part (defining the normal position), a slider part continuous to the lowest standby part, a flat part (defining disc-playback position) continuous to the slider part, and a projecting part continuous to the flat part. The normal position is the lowest position that the disc motor 13 has. The slider part changes in height in the circumferential direction. When the clamp ring 49 is rotated around its axis by a prescribed angle, each of the cam-abutting projections 13R, 13C and 13L moves from the standby part to projection part of the corresponding lift cam. As a result, the distance between the motor case (disc motor 13) and the chassis 11 is changed. The projecting part of the lift cam 49C is lower than those of the other lift cams 49R and 49L by a preset value. Therefore, the lift guides (three guides) provided on the chassis 11 guide the cam-abutting projections 13R, 13C and 13L, respectively. This restricts the position the disc motor 13 has in the plane direction. The motor-pushing springs 45, which are stretched over the three pairs of hooks 47 formed on the chassis 11, push the cam-abutting projections 13R, 13C and 13L onto the lift cams 49R, 49C and 49L. The disc motor 13 is thereby set at a specific position in the height direction. The projection parts of the lift cams 49R, 49C and 49L of the clamp ring 49 serve to lift the disc motor 13 a little higher when the optical disc is clamped (chucked) than when the optical disc is rotated to reproduce signals from it or to record signals in it. Therefore, the projection parts of the lift cams 49R, 49C an 49L are useful to raise the disc motor 13, making it easier to clamp the optical disc.

The clamp ring 49 has a ring-engagement projection 49a on the outer circumferential surface. The ring-engagement projection 49a is set in engagement with an end of the clamp lever 37 rotatably supported on the chassis 11. Note that a cam-engagement projection 37b is provided at the other end of the clamp lever 37. The cam-engagement projection 37b is set in the clamp-cam groove 27a made in the cam slider 27, which slides back and forth on the bottom cover 11. Thus, as the cam slider 27 slides so, the clamp lever 37 and the clamp ring 49 are rotated.

FIG. 6 shows how an optical disc is released from the turntable 15 (from the clamped or chucked state) in the optical disc apparatus 1.

The turntable 15, which is integrally formed with the disc motor 13, has a disc-mounting surface. The turntable 15 has ball-chucking claws 15a (three claws) for pressing an optical disc onto the disc-mounting surface (i.e., one side of the motor case of the disc motor 13). A part of the motor case serves as a clamping case 15b (housing) and a base 15c (table unit). The clamping case 15b can fit in the center hole of the optical disc loaded. The base 15c can support that part of the optical disc which surrounds the center hole thereof. The ball-chucking claws 15a exert a prescribed pressure toward the outer circumference of the optical disc and to the bottom of the disc motor 13 (i.e., chassis 11). Thus, the claws 15a push the optical disc onto the bottom of the disc motor 13 (that is, onto the chassis 11).

A top cover 111 has a motor-case (turntable) hole 111a and a clamping rib 111b. The motor-case hole 111a prevents the disc motor 13 from contacting the turntable 15 and the ball-chucking claws 15a when the clamp ring 49 is rotated, moving the disc motor 13 up to the chucking (clamping) position (or to the projecting parts of the lift cams 49R, 49C and 49L). The clamping rib 111b pushes the ball-chucking claws 15a to the bottom cover 11 so that the ball-chucking claws 15a may reliably hold the optical disc. Hence, the optical disc can be reliably held on the turntable 15 when the clamp ring 49 is rotated.

On the chassis 11A a disc-releasing projection 101 is provided. The disc-releasing projection 101 releases the optical disc from the chassis 11 in spite of the ball-chucking claws 15a when the clamp ring 49 is rotated, moving the disc motor 13 down. As a result, the optical disc can be ejected from the optical disc apparatus 1. Thus, the optical disc can be reliably released from the turntable 15 and the chucking claws 15a when the clamp ring 49 is rotated, moving the disc motor 13 down (toward the chassis 11).

That is, the clamp ring 49 is rotated, moving the disc motor 13 up or down as the cam slider 27 slides, in the present embodiment. When the disc motor 13 is moved up, the disc motor 13 is clamped (chucked) to the turntable 15. When the disc motor 13 is moved down, the disc motor 13 is released from the turntable 15.

More specifically, to clamp an optical disc, the disc motor 13 is moved up. As the disc motor 13 is up, the optical disc is moved up, too, because it interferes with the chucking claws 15a of the turntable 15 integrally formed with the motor case. At this time, the optical disc is held by the chucking claws 15a and pushed onto the disc-mounting surface of the turntable 15 secured to the shaft of the disc motor 13. As the optical disc is so pushed, it is held by the clamping rib 111b and axially aligned with the clamping case 15b (housing) of the turntable 15.)

To release the optical disc from the clamped state, the disc motor 13 is moved down. The optical disc, which is pushed onto the turntable 15 by the chucking claws 15a, is thereby moved down. At this time, the optical disc abuts on the disc-releasing projection 101 and is released from the chucking claws 15a and, hence, from the turntable 15.

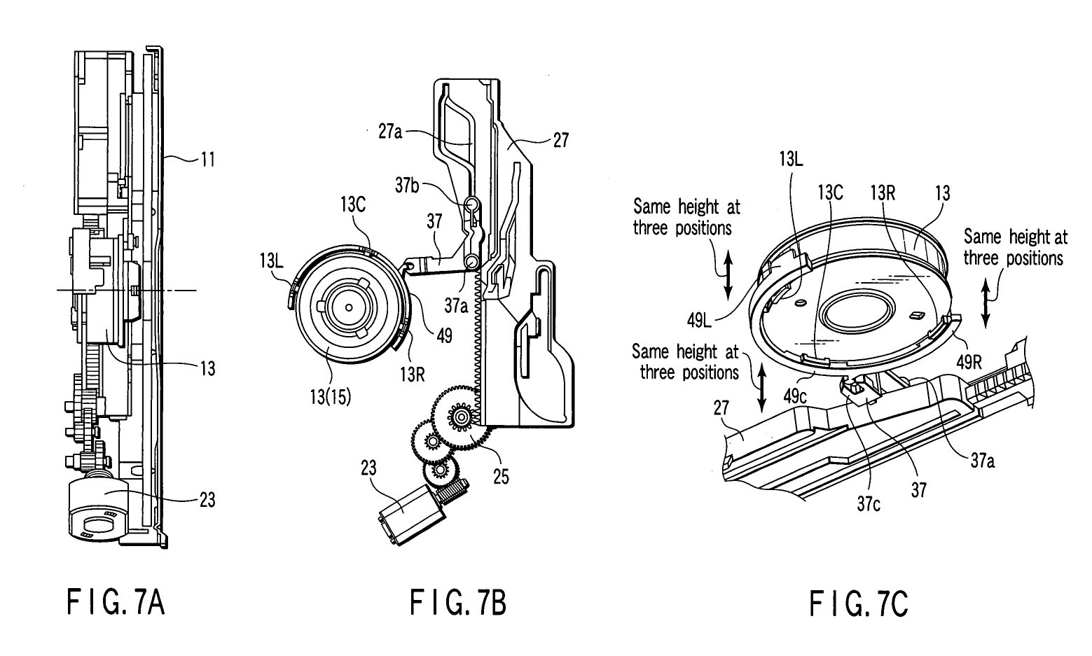

How the disc motor 13 is moved down or up as the cam slider 28 slides will be described in detail with reference to FIGS. 7A to 7C, FIGS. 8A to 8C and FIGS. 9A to 9C. Of these figures, FIGS. 7A, 8A and 9A show the positional relation between the disc motor 13 and the chassis 11, FIGS. 7B, 8B and 9B show the relation between the parallel motion of the cam slider 27 and the rotations of the clamp ring 49 and clamp lever 37, and FIGS. 7C, 8C and 9C show the positional relation between the disc motor 13 and the lift cams 55R, 55C and 55L of the clamp ring 49.

FIGS. 7A to 7C show the disc motor 13 at the “down” position, or normal position, where the motor 13 remains closest to the chassis 11. As clearly seen from FIG. 7B, the line connecting the fulcrum 37a and cam-engagement projection 37b of the clamp lever 37 is almost parallel to the rack-gear section of the cam slider 31. While the disc motor 13 remains at the “down” position, the lift cams 49R, 49C and 40L formed on the clamp ring 49 stay at the lowest position (standby position), and the cam-abutting projections 13R, 13C and 13L of the disc motor 13 stay at the lowest position, substantially close to the chassis 11, and are held in horizontal position.

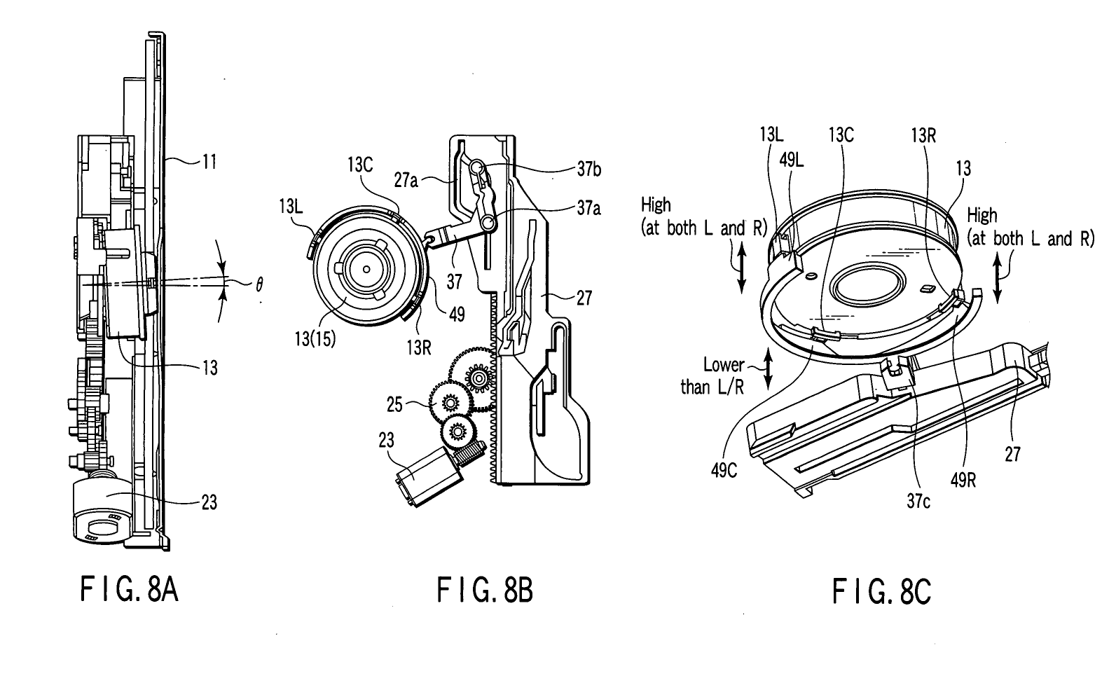

FIGS. 8A to 8C show the lift cams 49R, 49C and 49L of the clamp ring 49, which are set at a sloping part between the “down” position (standby position) and disc-playback position (planar position) of the disc motor 13, or positioned at the slider section for moving the disc motor 13 up and down. As seen from FIG. 8B, the line connecting the fulcrum 37a and cam-engagement projection 37b of the clamp lever 37 is not parallel to the rack-gear section of the cam slider 31. As seen from FIG. 8A, the disc motor 13 inclines by angle θ due to the slider section, to the perpendicular to the center hole 11a made in the chassis 11, or to the shaft of the disc motor 13 set at the normal position or disc-playback position. The angle θ of inclination is defined because the projection part of the lift cams 49C has a smaller height than the projection parts of the lift cams 49R and 49L.

The pushing force, which acts between the chucking claws 15a and the center hole of the optical disc to clamp (chuck) the disc or release the disc as explained with reference to FIG. 6, can therefore be more reduced than in the case where the disc motor 13 is moved in parallel only.

To clamp (chuck) the optical disc, the disc motor 13 is inclined a little (by angle θ) and then moved to the clamping position. To release the optical disc from the clamped state (i.e., chucked state), the disc motor 13 is inclined a little (by angle θ) and then moved from the clamping position. Hence, a small load suffices to clamp (chuck) the optical disc and to release the optical disc from the clamped (chucked) state.

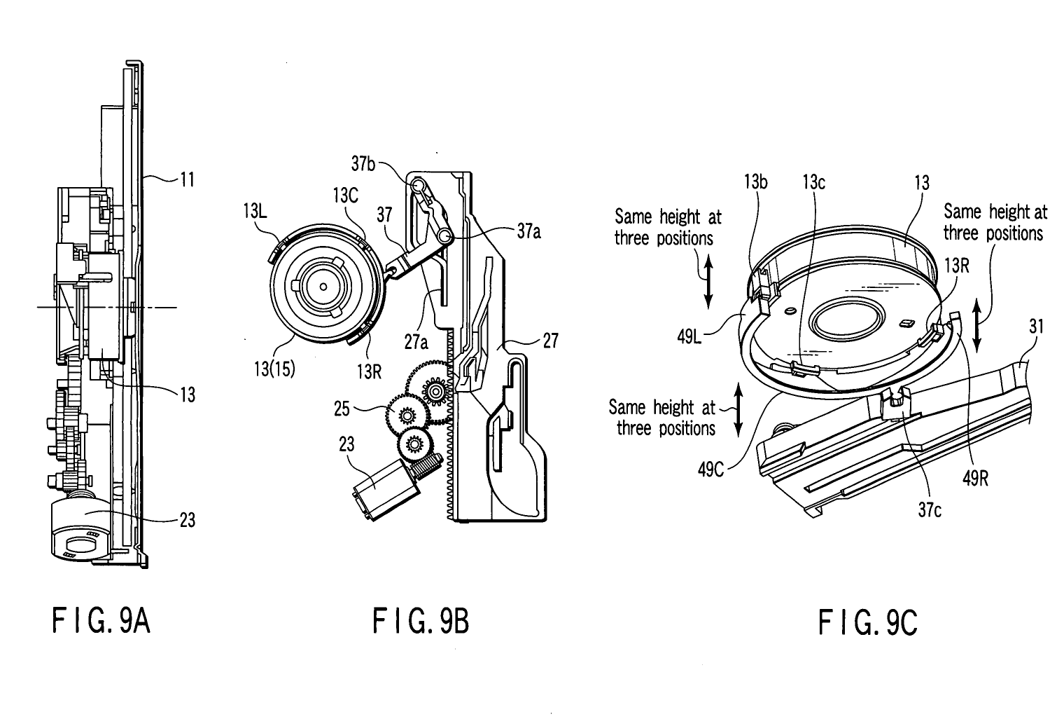

FIGS. 9A, 9B and 9C show the disc motor 13 in a completely clamped state. More precisely, they show the cam-abutting projections 13R, 13C and 13L of the disc motor 13, which are set at a planar position (disc-playback position), or at the same height as the lift cams 49R, 49C and 49L of the clamp ring 49. As seen from FIG. 9B, the line connecting the fulcrum 37a and cam-engagement projection 37b of the clamp lever 37 and the rack-gear section of the cam slider 27 defines the largest angle. (The clamp-cam groove 27a made in the cam slider 27 inclines at the largest angle to the rack-gear section.) At this time, the cam-abutting projections 13R, 13C and 13L of the disc motor 13 are pressed on the lift cams 49R, 49C and 49L of the clamp ring 49, respectively, and are therefore held in horizontal position.

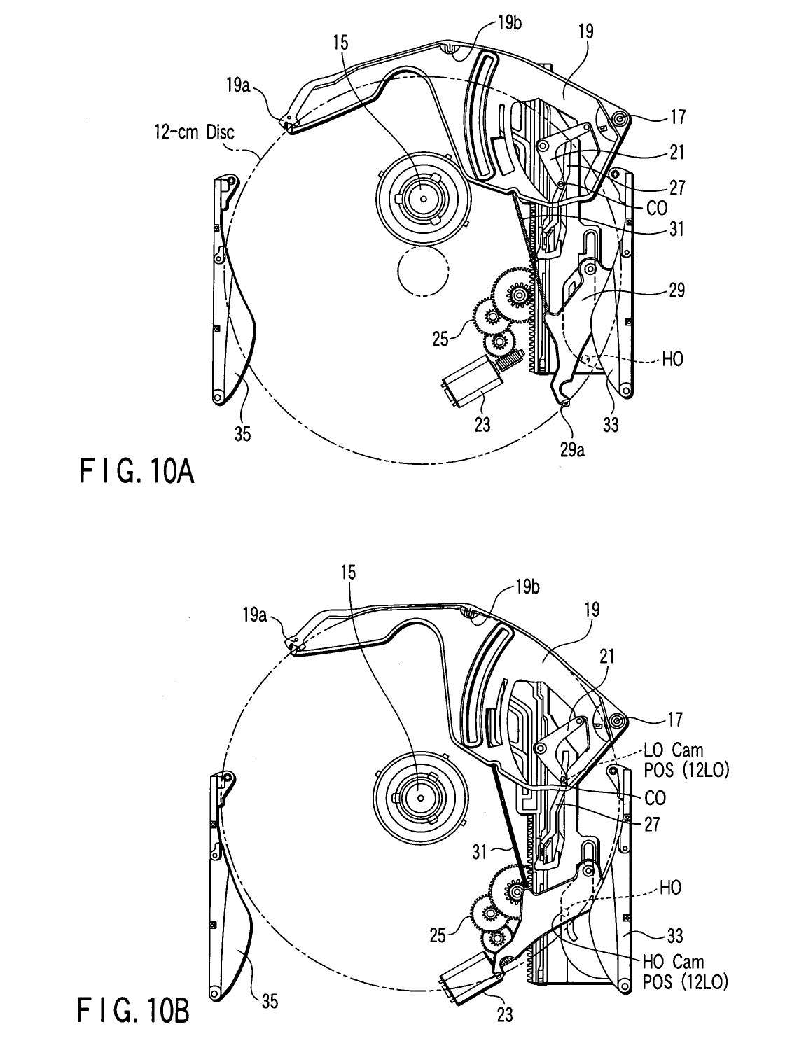

Since the cam slider 27 moves in parallel as shown in FIG. 7B, FIG. 8B and FIG. 9B, a 12-cm disc and an 8-cm disc can be easily loaded and positioned in the optical disc apparatus 1, as will be explained later with reference to FIGS. 10A and 10B, FIGS. 11A and 11B and FIG. 12.

FIGS. 10A and 10B depict the mechanical base chassis 11 as viewed from above and from below.

As shown in FIG. 10A, an optical disc (12-cm disc) is inserted (or pushed) into the optical disc apparatus 1 in the direction of arrow A. The outer circumference of the optical disc eventually contacts, at a given point, the disc holding pin 29a of a disc holding lever 29. The optical disc is thereby guided toward the loading arm 19 (and toward the turntable 15) and contacts the first positioning projection 19a of the loading arm 19. As described above, the disc holding lever 29 and the loading arm 19 are exerted with a predetermined tension and pulled toward the turntable 15. The optical disc is therefore guided to the turntable 15, while being supported by the disc holding lever 29 and the loading arm 19.

As the optical disc is further pushed in this state, the loading arm 19 rotates around the fulcrum 17, moving away from the turntable 15.

As the optical disc is inserted still further into the optical disc apparatus 1 (or as the loading arm 19 is rotated), the fulcrum 33a of the first disc guide 33 and the fulcrum 35a of the second disc guide 35 are gradually moved outwards, preventing the optical disc from moving in any undesirable manner.

As the optical disc is pushed deeper into the apparatus 1, the fulcrums 33a and 35a of the first and second disc guides 33 and 35 each includes a main disc guide element and a sub disc guide element connected by the fulcrums 33a and 35a respectively, are moved to their outermost positions. As a result, the main disc guide element and sub disc guide element of the first disc guide 33 extend in a substantially straight line, and the main disc guide element and sub disc guide element of the second disc guide 35 extend in a substantially straight line. Then, the disc holding lever 29 and the loading arm 19 transports the optical disc until the center of the optical disc reaches the turntable 15.

As the disc holding lever 29 and the loading arm 19 are rotated, the optical disc held by the disc holding lever 27 and the loading arm 19 is further transported until its center aligns with the center of the turntable 15 as shown in FIG. 10B. At this point, the first and second positioning projections 19a and 19b of the loading arm 19 cooperate, reliably aligning the center of the optical disc with the center of the turntable 15.

More precisely, as the 12-cm disc is inserted into the optical disc apparatus 1, the first and second disc guide 33 and 35 are moved outwards. When the optical disc reaches a sufficiently deep position (FIG. 10B), the cam slider 27 is driven by a loading motor (not shown), further transporting the optical disc held between the first and second positioning projections 19a and 19b of the loading arm 19 and the disc holding pin 29a of the disc holding lever 29.

As the cam slider 27 further slides, the engagement projection CO of a connection lever 21 enters an LO cam POS (12LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 29 enters an HO cam POS (12LO). Then, the disc holding pin 29a moves, pushing the optical disc until the center of the disc aligns with the center of the turntable 15 (or the shaft of the disc motor 13). The optical disc is thereby set at a prescribed position on the turntable 15, where it should be clamped.

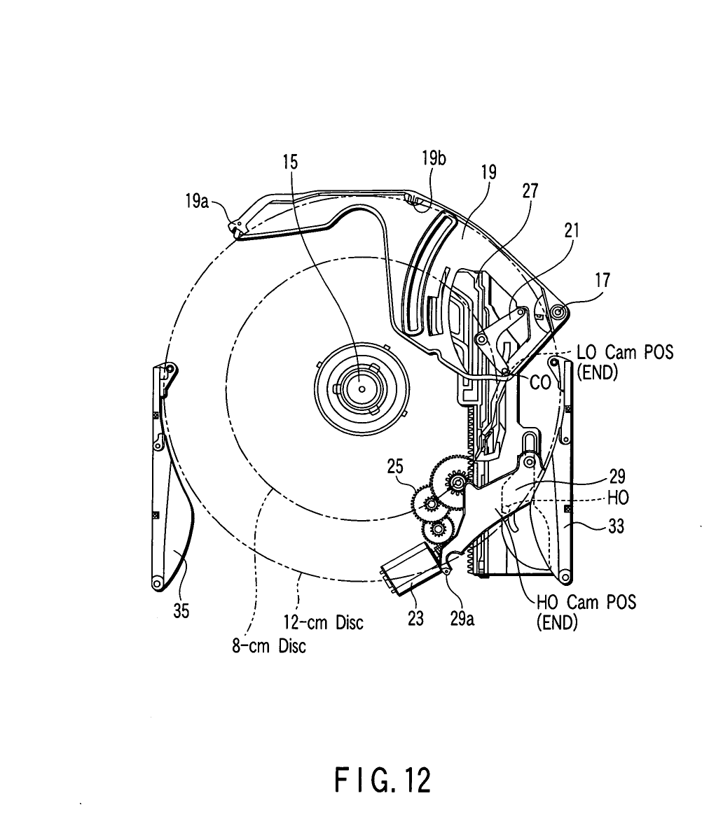

As the optical disc is inserted into the optical disc apparatus 1 as has been described with reference to FIGS. 7A to 7C, 8A to 8C, and 9A to 9C, the turntable 15 (disc motor 13) is moved upwards from the standby position near the mechanical base chassis 11. The optical disc is thereby clamped on the turntable 15. As a result, the optical disc is set in the optical disc apparatus 1 and can be rotated, as shown in FIG. 12.

In order to rotate the optical disc, a spring-force releasing mechanism (not shown) releases the disc holding lever 29 and the loading arm 19 from the tension that biases them toward the turntable 15 as shown in FIG. 12. Thus, the disc holding lever 29 and the loading arm 19 are inhibited from contacting the outer circumference of the optical disc.

In order to eject the optical disc, the loading arm 19 is rotated in the opposite direction (to move the optical disc to the disc-ejecting position). The optical disc can therefore be ejected with ease.

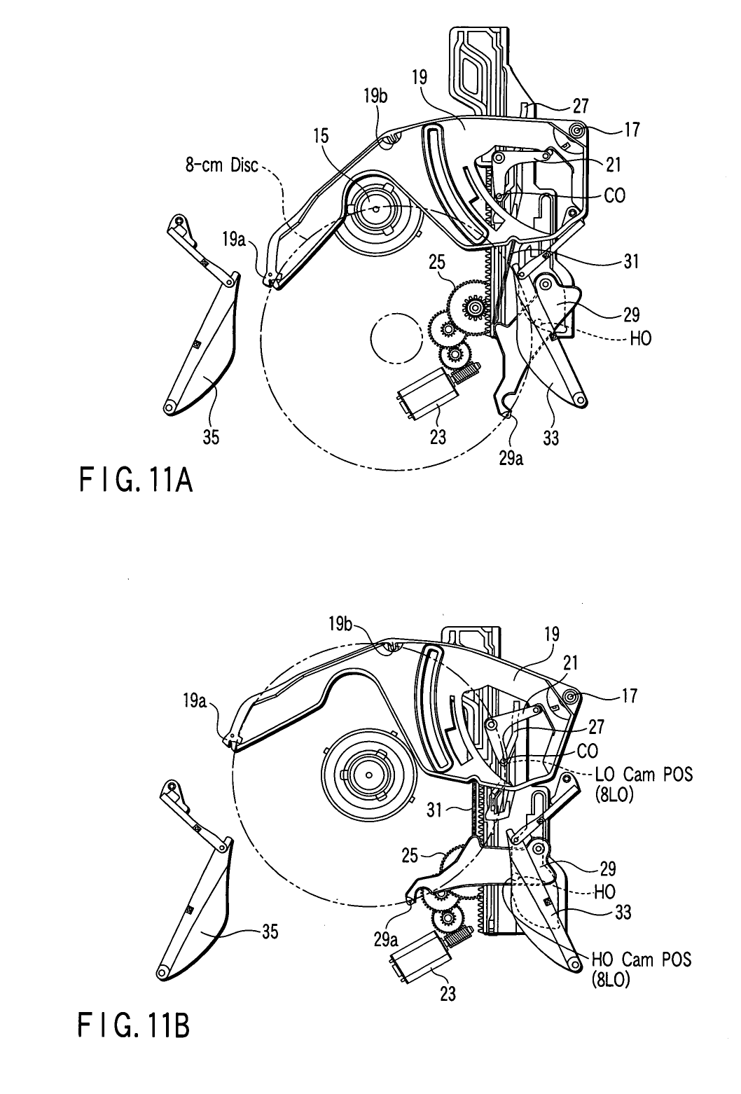

An 8-cm optical disc may be inserted (or pushed) into the optical disc apparatus 1 in the direction of arrow A. In this case, as shown in FIG. 11A, the outer circumference of the optical disc eventually contacts the disc holding pin 29a of the disc holding lever 29. The optical disc is then guided toward the loading arm 19 (and toward the turntable 15) and contacts the first positioning projection 19a of the loading arm 19. As described above, the disc holding lever 29 and the loading arm 19 are exerted with a predetermined tension and pulled toward the turntable 15. The optical disc is therefore guided to the turntable 15, while being held by the disc holding lever 29 and the loading arm 19.

As the optical disc is further pushed in this state, the loading arm 19 rotates around the fulcrum 17, moving away from the turntable 15.

At this time, the fulcrums 33a and 35b of the first and second disc guides 33 and 35, respectively, prevent the optical disc from moving in any undesirable manner. They can yet position the optical disc at substantially the center of the optical disc apparatus 1, almost at their initial positions or virtually without rotating (see FIGS. 11A and 11B), unlike in the case where a 12-cm disc is inserted into the optical disc apparatus 1. FIG. 11A shows the optical disc immediately before its center aligns with the center of the turntable 15.

As the disc holding lever 29 and the loading arm 19 are further rotated, the optical disc held by the disc holding lever 29 and the loading arm 19 is transported until its center aligns with the center of the turntable 15 as shown in FIG. 11B. At this point, the first and second positioning projections 19a and 19b of the loading arm 19 cooperate, reliably aligning the center of the 8-cm optical disc with the center of the turntable 15.

As shown in FIG. 11A, the 8-cm optical disc is guided into the optical disc apparatus 1, while contacting the first and second positioning projections 19a and 19b of the loading arm 19 and being positioned near the first and second disc guides 33 and 35 and near the fulcrums 33a and 35a thereof. As the cam slider 27 is driven by a loading motor (not shown), the optical disc is further transported deeper into the optical disc drive 1 by the disc holding pin 29a of the disc holding lever 29.

As the cam slider further slides, the engagement projection CO of the connection lever 21 enters an LO cam POS (8LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 29 enters the HO cam POS (8LO). Then, the disc holding pin 29a moves, pushing the optical disc until the center of the disc aligns with the center of the turntable 15 (or the shaft of the disc motor 13). The optical disc is thereby set at a prescribed position on the turntable 15, where it should be clamped. Since the disc has a diameter of 8 cm, the cam slider 31 does not move so much as in the case of inserting a 12-cm disc.

When the optical disc is rotated, it rotates around the rotation axis of the disc motor 13, around which the loading arm 19 and the clamp ring 49 rotate. Hence, the disc motor 13 secured to the clamp ring 49 by the motor-pushing springs 45 is rotated by a predetermined angle around its rotation axis. The spring-force releasing mechanism (not shown) releases the loading arm 19 and disc holding lever 29 from the tension that biases them toward the turntable 15. Thus, the loading arm 19 and the disc holding lever 29 are inhibited from contacting the outer circumference of the optical disc.

The cam slider 27 can move in parallel in the chassis 11 as the forward or inverse rotation of the loading motor 231 is transmitted to it by the series of gears 25. Assume that the cam slider 27 moves in the direction of arrow B shown in FIG. 3. Then, the clamp lever 37 is rotated in the direction of arrow C. The rotation of the camp lever 37 supports the disc motor 13.

In the slot-in type optical disc apparatus, the loading motor 23 is limited in size and torque in many cases. Due to this, the reduction ratio of the series of gears 25 is set to a large value as in many cases. In view of this, it is demanded that the optical disc should be reliably removed from the optical disc apparatus, even in emergency, when the apparatus is stopped due to, for example, failure of the power supply, while the optical disc is being pulled into or ejected from the optical disc apparatus. Nonetheless, it is difficult to move the cam slider 27 as long as the series of gears 25 remains in mesh with a worm gear (not shown) fastened to the loading motor 23, in order to move the cam slider 27 that is used to load and eject an optical disc.

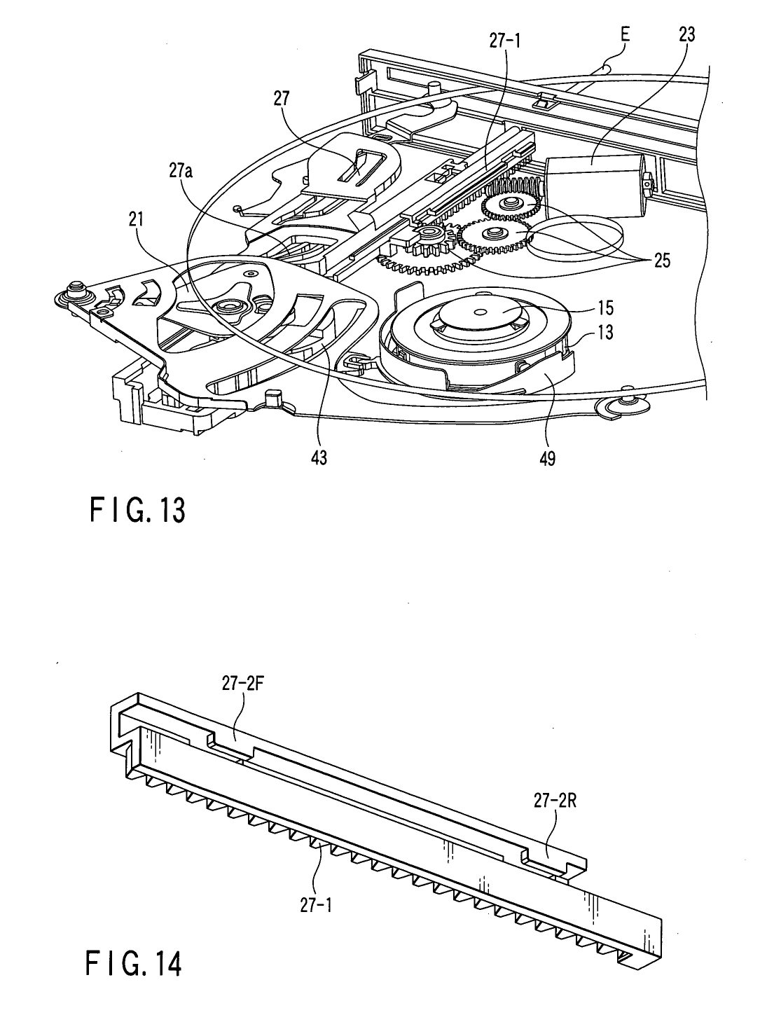

FIG. 13 shows a configuration that can release the cam slider from the series of gears to make it easy to eject an optical disc in emergency in the optical disc apparatus shown in FIG. 1.

As shown in FIG. 13, the rotation of the loading motor 23 is transmitted via the series of gears 25 to the rack slider 27-1 of the cam slider 27.

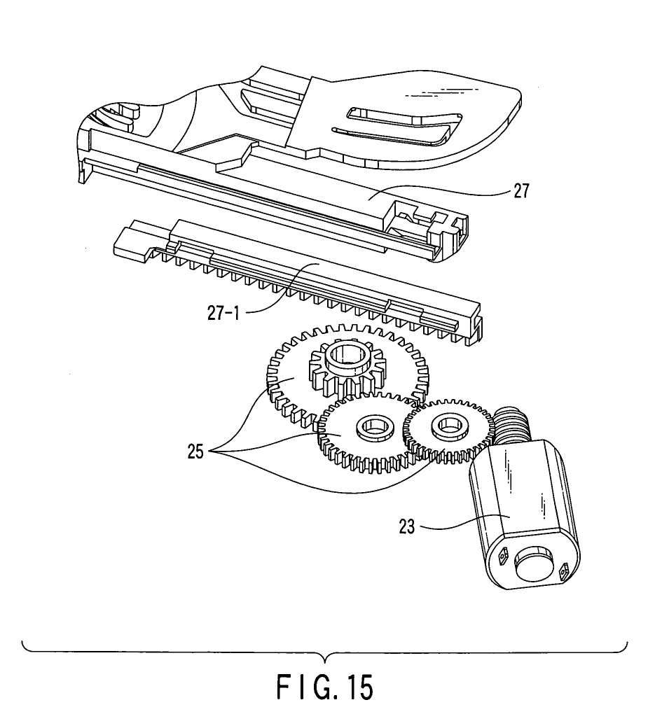

As FIGS. 14 and 15 show, the rack slider 27-1 has two guide ribs, i.e., front guide rib 27-2F and rear guide rib 27-2R. The rack slider 27-1 is coupled with the main part of the cam slider 27.

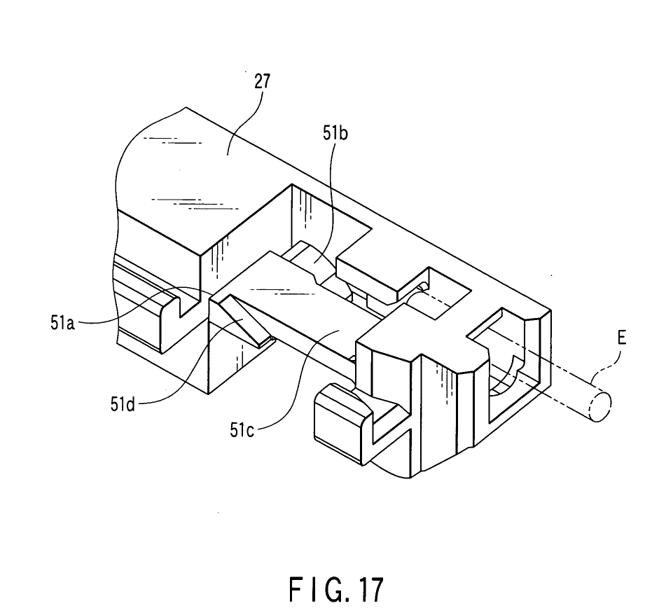

The rack slider 27-1 can therefore be moved back and forth as shown in FIG. 17A in the normal operating condition, in the disc-loading direction (arrow A) and the disc-ejecting direction (arrow B).

As has been explained, the cam slider 27 should be moved in the direction of arrow B to move the loading arm 19 away from the disc motor 13 (from turntable 15) in order to load an optical disc. To this end, the loading motor 23 is rotated in a prescribed direction, and the gears 25 are provided in predetermined numbers and arranged in a specific manner.

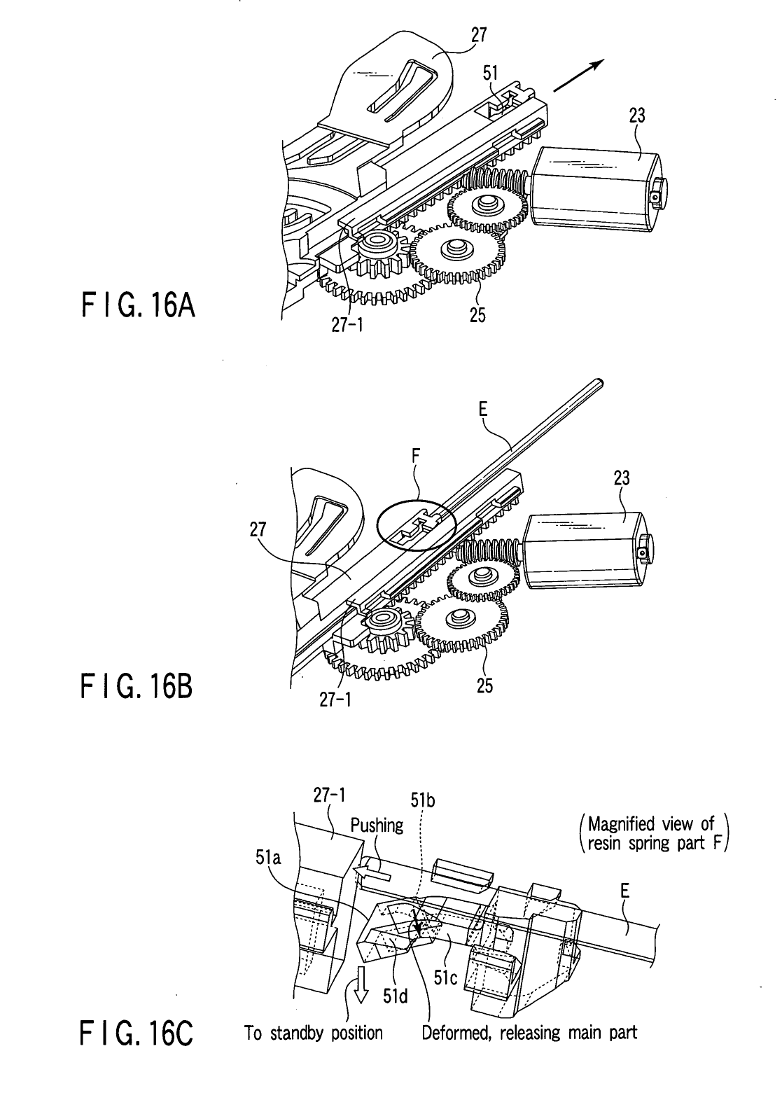

To eject the optical disc in emergency, a release pin E is inserted as shown in FIG. 3. Then, as shown in FIGS. 16B and 16C, a resin spring part (deforming part) 51 provided adjacent to the main part of the cam slider 27 is deformed, releasing the main part of the cam slider 27 from the rack slider 27-1. Needless to say, FIG. 16C is a magnified view of the resin spring part (deforming part) designated by “F” in FIG. 16B.

That is, the rack slider 27-1 is separated from the main part of cam slider 27 while it remains in mesh (engagement) with the series of gears 25 at the front guide rib 27-2F. Thus, when the release pin E is inserted deeper, only the main part of the cam slider 27 moves back (in the disc-ejecting direction), independently of the rack slider 27-1.

When the cam slider 27 moves back, the loading arm 19 and disc holding lever 29 are rotated and moved back from the disc-loading end position described with reference to FIG. 10B or 11B to the disc-loading start position shown in FIG. 10A or 11A. The moment the cam slider 27 moves back, the apparatus 1 shifts from the disc-clamping (chucking) state shown in FIG. 9 to the disc-releasing (de-chucking) state shown in FIGS. 7 and 8, whereby the optical disc is ejected from the apparatus 1. At the same time, the first and second disc guides 33 and 35 are returned to their initial positions (i.e., the positions they take when no discs are inserted.)

Hence, even if emergency arises while an optical disc remains clamped as shown in FIGS. 9A to 9C, the loading arm 19 can be rotated in the disc-ejecting direction to eject the optical disc through the insertion slot 39a, by merely inserting the release pin E through the pin insertion hole 39b of the bezel 39.

As shown in FIG. 17, the resin spring part 51 of the cam slider 27 includes an engagement wall 51a, a deforming part 51b, a release-pin contacting surface (first sloping surface) 51c, and a reset surface (second sloping surface) 51d. The engagement wall 51a couples the rack slider 27-1 to the main part of the cam slider 27. The deforming part 51b can undergo elastic deformation. The release-pin contacting surface 51c exerts a force when the release pin E is inserted. This force deforms the deforming part 51b, whereby the cam slider 27 comes out of contact with the engagement wall 51a. The reset surface 51d receives the front guide rib 27-2F of the rack slider 27-1, applying a predetermined pressure to the front guide rib 27-2F, when the apparatus 1 is reset as will be described below.

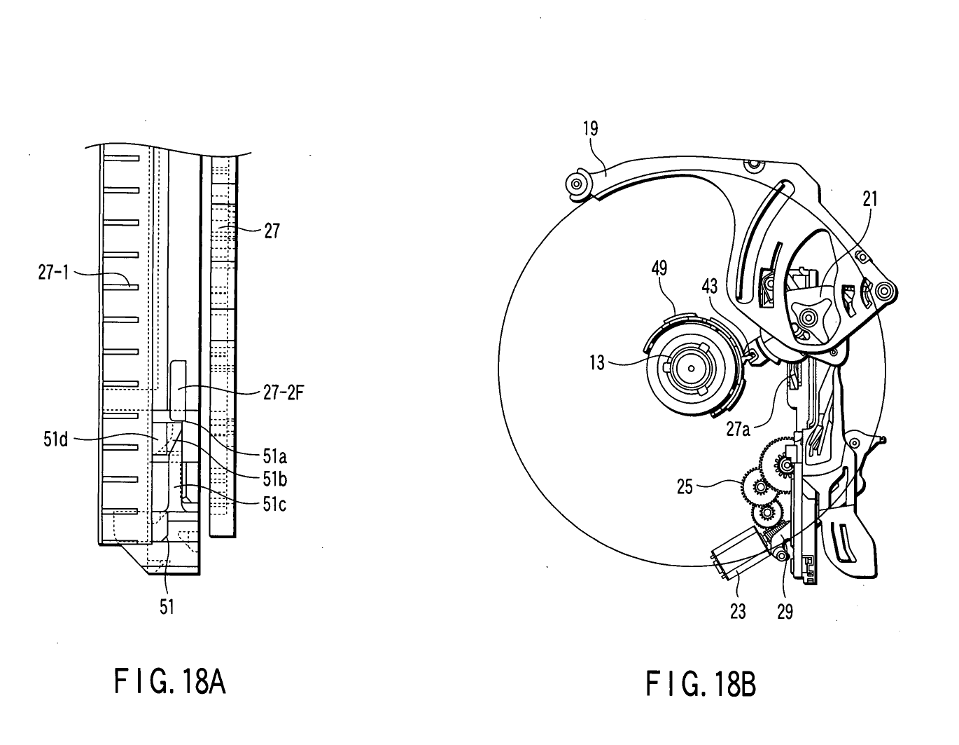

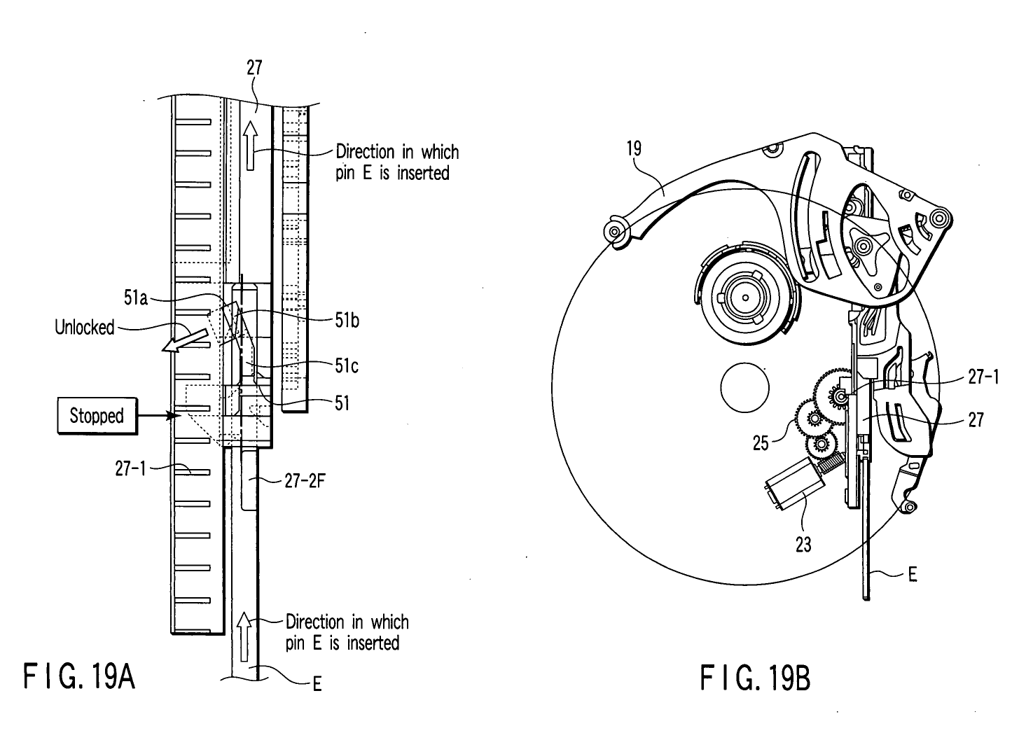

In the normal operating condition, the resin spring part 51 of the cam slider 27 has its engagement wall 51a contacting one end of the front guide rib 27-2F of the rack slider 27-1 as shown in FIGS. 18A and 18B. Thus, the resin spring part 51 contacts one end of the rack slider 27, whereby the cam slider 27 and the resin spring part 51 are coupled to each other. Further, as shown in FIGS. 19A and 19B, the release-pin contacting surface 51c (first sloping surface) of the resin spring part 51 is released from the guide rib 27-2F as it is deformed when the release pin E is inserted.

When the loading motor 23 is rotated as the apparatus 1 is reset, a returning sequence is performed to move the cam slider 27 deep into the chassis 11, or to a disc-ejecting position. More precisely, the rack slider 27-1 is moved deep into the chassis 13, because it is no longer coupled to the main part of the cam slider 27 and can therefore move independently of the cam slider 27.

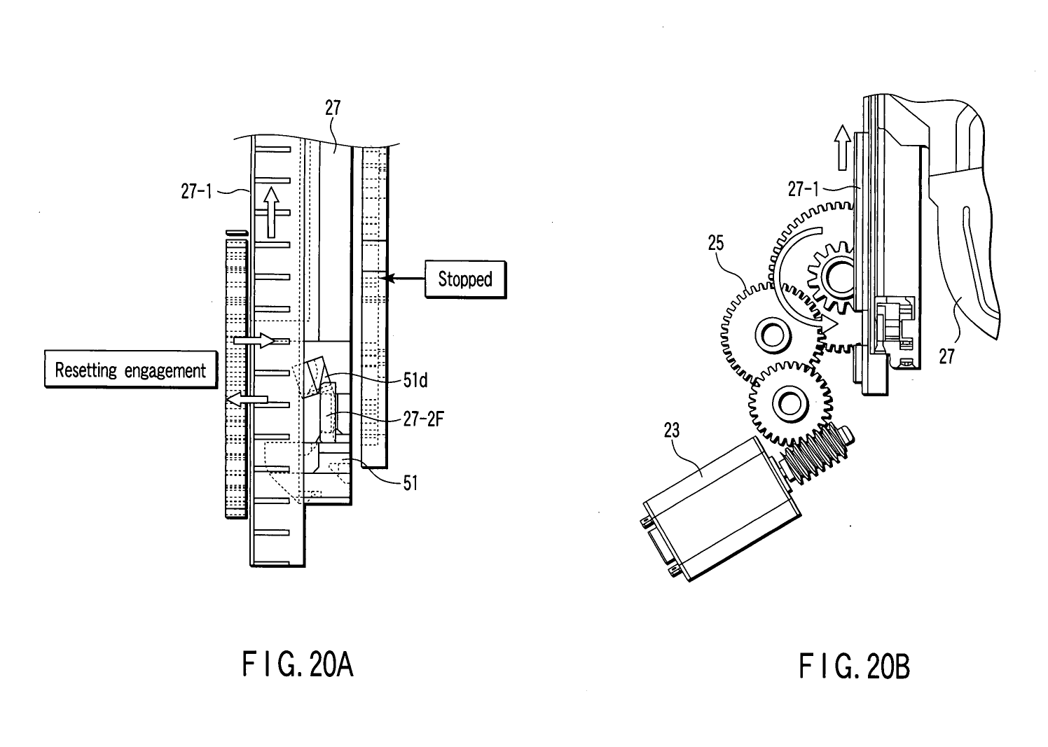

At the time the returning sequence is completed, the deforming part 51b of the resin spring part 51 contacts the guide rib 27-2F and is deformed, as is illustrated in FIGS. 20A and 20B. Then, the deforming part 51b restores its shape, causing the engagement wall 51a to move along the reset surface 51d (second surface) until the wall 51a contacts the guide rib 27-2F. As a result, the rack slider 27-1 is coupled again with the main part of the cam slider 27. The returning sequence can be easily performed if the loading motor 23 is rotated in one direction for a predetermined time (about hundreds of milliseconds) and is then held in the initial state (i.e., the state it assumes immediately after it is set up in non-emergency condition). The returning sequence is an ordinary one that may set a relatively long time for which the loading motor should be rotated to eject an optical disc, at ordinary setup of the optical disc apparatus.

Instead of using the method of rotating the loading motor for the predetermined time, a detection switch may be provided at a prescribed position deep in the chassis 11, where the rack slider 27-1 should be stopped and may detect the position of the rack slider 27-1, to stop rotating the loading motor 23 when the switch detects the rack slider 27-1. Alternatively, the above-mentioned method and this method of stopping the loading motor may be used together.

As has been described, in one embodiment of this invention, the slider mechanism that transmits the rotation of the loading motor to the transport mechanism that transports an optical disc to chuck the disc to the disc motor for rotating the optical disc is slid in an direction opposite to the direction in which the optical disc is transported. In the event of a loading error (an emergency), the slider mechanism is moved in a direction from outside, thereby inverting the operation of the slider mechanism. This facilitates the removal of the optical disc, which would otherwise remain in the optical disc apparatus.

The rack-gear section that transmits the rotation of the loading motor to the slider mechanism can be moved and released from the engagement with the slider mechanism in preparation for ejecting the disc. Therefore, in the event of a loading error (an emergency), the slider mechanism can be moved back to its initial position after the optical disc has been removed from the apparatus, in a sequence that is virtually identical to the ordinary setup of the optical disc apparatus.

Moreover, the mechanism that de-couples the rack-gear section, which transmits the rotation of the loading motor to the slider mechanism, from the slider mechanism as the slider mechanism moves in such a direction as to eject the disc, can be provided only if its one part is shaped in a specific manner, unlike the slider mechanism designed for use in the ordinary sliding operation. Hence, there will be no increase in the manufacturing cost of the optical disc apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a disc motor which is configured to hold and rotate an optical disc;
a loading motor which exerts a drive force for loading and chucking the optical disc to the disc motor and for ejecting the optical disc after the optical disc has been de-chucked from the disc motor;
first and second guide arms which guide the optical disc to a chucking position where the disc should be chucked to the disc motor, by using the drive force provided by the loading motor;
a disc-motor lifting mechanism which rotates the disc motor, thereby chucking the optical disc, when the first and second guide arms transport the optical disc to the chucking position where the disc should be chucked to the disc motor;
a slider mechanism which is moved in a direction opposite to the direction in which the first and second guide arms transport the optical disc, in order to load or eject the optical disc, and which transmits a drive force provided by the loading motor to the first and second guide arms and to the disc-motor lifting mechanism;
a transmission mechanism which transmits a drive force of the loading motor to the slider mechanism; and
a cut off mechanism which cuts off the drive force being transmitted by the transmission mechanism from the loading motor to the slider mechanism.

2. The apparatus according to claim 1, wherein the slider mechanism has a rack section for receiving the drive force from the transmission mechanism and a sliding section for transmitting a drive force provided by the loading motor, to the first and second guide arms and to the disc-motor lifting mechanism, and the cut off mechanism elastically deforms the rack section and sliding section by using a force that moves the slider mechanism in the direction opposite to the direction in which the first and second guide arms transport the optical disc in order to load or eject the optical disc.

3. The apparatus according to claim 1, wherein the cut off mechanism has a first sloping surface for separating the rack section from the sliding section, by virtue of a force which is provided when a prescribed force is applied from outside and which moves the slider mechanism in the direction opposite to the direction in which the first and second guide arms transport the optical disc in order to eject the optical disc.

4. The apparatus according to claim 2, wherein the cut off mechanism has a second sloping surface for coupling the rack section to the sliding section, by virtue of a force which is provided while the rack section remains separated from the sliding section and which moves the slider mechanism in the direction opposite to the direction in which the first and second guide arms transport the optical disc in order to eject the optical disc.

5. The apparatus according to claim 4, wherein the force that moves the slider mechanism in the direction opposite to the direction in which the first and second guide arms transport the optical disc in order to eject the optical disc while the rack section remains separated from the sliding section is provided as the loading motor rotates in the same direction as the loading motor is rotated to eject the optical disc.

6. An optical disc apparatus comprising:
a cam slider main body with a rack-gear section; and
a slider mechanism which includes a first sloping surface that is elastically deformed, generating a force for separating the rack-gear section from the cam slider main body, when receiving a force that acts in the same direction as to eject an optical disc, and a second sloping surface that generates a force for coupling the rack-gear section to the cam slider main body again, when pressed with a force that acts in the same direction as the rack-gear section separated from the cam slider main body ejects an optical disc, which is moved in the direction opposite to the direction in which first and second guide arms transport the optical disc in order to load or eject the optical disc, and which transmits a drive force provided by a loading motor to the first and second guide arms.

7. The apparatus according to claim 6, wherein the slider mechanism includes a rack section for receiving a drive force from a transmission mechanism, a sliding section for transmitting the drive force provided by the loading motor to the first and second guide arms, and a cut off mechanism (51c) which elastically deforms to separate the rack section and the sliding section from each other, by using a force that moves the slider mechanism in a direction opposite to the direction in which first and second guide arms transport the optical disc in order to eject the optical disc.

8. The apparatus according to claim 7, wherein the cut off mechanism is able to separate the rack section from the sliding section of the slider mechanism by using the force which is provided when a prescribed force is applied from outside and which moves the slider mechanism in the direction opposite to the direction in which the first and second guide arms transport the optical disc in order to eject the optical disc.

9. The apparatus according to claim 7, wherein when the rack section is separated from the sliding section of the slider mechanism, the cut off mechanism is able to couple the rack section to the sliding section by using the force that moves the slider mechanism in the direction opposite to the direction in which the first and second guide arms transport the optical disc in order to eject the optical disc.
